(19) United States
(12) Patent Application Publication
(10) Pub. No.: US 2026/0023367 A1
(43) Pub. Date: Jan. 22, 2026

(54) System and Method for Open Multi-Agent Collaboration

(71) Applicant: Mitsubishi Electric Research Laboratories, Inc., Cambridge, MA (US)

(72) Inventors: Siddarth Jain, Cambridge, MA (US); Prasanth Suresh, Athens, GA (US); Prashant Doshi, Athens, GA (US); Diego Romeres, Boston, MA (US)

(73) Assignee: Mitsubishi Electric Research Laboratories, Inc., Cambridge, MA (US)

(21) Appl. No.: 18/777,632

(22) Filed: Jul. 19, 2024

(51) Int. Cl. G05B 19/418; G06N 3/092

(52) U.S. Cl. CPC G05B 19/418; G06N 3/092

(57) ABSTRACT

Embodiments disclosing a controller for controlling a collaboration of a set of agents jointly performing a task are provided. The set of agents includes different combinations of active agents and inactive agents defined by a collaboration variable. The controller is configured to accept a feedback signal including observations of a state of execution of the task performed by active agents, as specified in the collaboration variable. The observations are processed with a neural network trained with machine learning to determine actions for the active agents. The actions include one or more activation actions that cause activation or deactivation of a specific agent from the set of agents. The collaboration variable is updated when the neural network outputs at least one activation action to update a combination of active and inactive agents and cause the active agents to execute the determined actions.

### TECHNICAL FIELD

The present disclosure relates generally to a robotic control system, and more specifically to a robotic control system performing open multi-agent collaboration for a set of agents.

### BACKGROUND

Multi-agent environments requiring collaboration between different agents have been ever evolving. In some such environments, agents include humans and robots, and the collaboration between humans and robots leverages the distinctive and often complementary strengths of both humans and robots. Robots, possessing sensory perception and intelligent decision-making capabilities, serve as collaborators across various applications. Some such applications include robotic assembly, robotic path planning, robotic control, and the like.

In human-robot collaborations, the monotonous and force-intensive tasks may be performed by the robot, while the cognitively demanding and dexterous manipulation tasks may be conducted by humans. In such multiagent environments, agent openness refers to the ability of an agent to join or leave a task at any point based on their requirement in the task. For agent openness, accurate modeling of open systems that have uncertainties regarding goals, active agents, and their characteristics is needed.

Effective strategies for modeling open systems requiring human robot collaboration are thus required to leverage the capabilities of different agents effectively in multi-agent environments.

### SUMMARY

Accordingly, some embodiments disclose systems and methods to model agent openness in human-robot collaborations. To that end, some embodiments disclose learning-from-demonstrations (LfD) methods to model agent openness.

Some embodiments are based on a realization that modeling agent openness solely based on agent coalition, without taking into factor current state and actions of the agents is unrealistic and impracticable in realistic scenarios where the decision to switch between different coalitions is made based on a policy action, which is contingent on the current agents' state. Also, since this state definition corresponds to the world state, even attributes affected by currently inactive agents may be tracked throughout, causing redundancy.

Some embodiments are further based on a recognition that modeling ad hoc collaboration between agents may be done using a simulator, using a teacher-learner framework to model agent openness and validate the model using a simulated wildfire suppression domain. A partially observable open stochastic Bayesian game model may be further used for agent openness with a graph-based policy learning approach. However, performing such simulations is only feasible for small, simulated toy domains that may not scale well to real-world scenarios.

To that end, some embodiments are based on a recognition that modeling ad hoc collaboration between a set of agents is effective when learning focused on how one agent can collaborate with previously unseen agents, contrary to agent openness in the context of open systems, where any agent can dynamically enter and exit the task at different points.

Some embodiments are further based on a realization that multiagent models wherein a predetermined set of human and robotic agents work together to accomplish a task from start to finish, are closed system representations which lack adaptability and flexibility provided by open systems. To that end, some embodiments are based on a recognition that an open system is more adaptable and flexible in allowing any agent to join or depart the task at any stage as required. This modality of openness is termed agent openness. Some embodiments are based on a recognition that a “dyadic” system which typically refers to a system or interaction involving two elements or entities, may be used to model a human-robot collaborative robotic system, in which one entity is a robot and another entity is a human. For example, in collaborative robotics, a dyadic interaction might involve a robot and a human worker collaborating on a task, where both entities communicate and coordinate their actions in real-time. Dyadic control schemes, such as bilateral teleoperation, are often used in such scenarios, where the actions of one entity (e.g., the human) directly affect the actions of the other entity (e.g., the robot), and vice versa. To that end, some embodiments disclose a dyadic control system that allows humans to effortlessly join and collaborate with robots when their assistance is needed. Such a system for human robot collaboration (HRC) may be referred to hereinafter as an open-HRC system (OHRCS).

Some embodiments are based on a recognition that the OHRCS may have some challenges related to the collaboration of the agents. For example, in a collaborative dyadic table assembly task consisting of many components, there may be multiple valid orders to complete the assembly and only a small subset of tasks that may require human assistance. Subsequently, there may be a particular order that minimizes the time and effort of the human while optimally completing the assembly. In such cases, the primary challenge becomes designing a model that can capture the variety of possible behaviors. This multiagent model must accurately depict the behavior of the current team of agents, the behavior of any new agent that has joined, and the task itself. Some embodiments are based on a recognition that most real-world domains tend to be decentralized (i.e. each agent may not have complete information about the others), the multiagent model for such a decentralized system must capture such dynamics. Some embodiments are further based on a recognition that the multiagent model would benefit from a reward

function that can induce behavior (into the robotic control system) that solves the task optimally while balancing the reward and higher step-cost accrued by utilizing human assistance. Some embodiments are further based on a recognition that such reward shaping is a non-trivial problem.

To that end, it is an object of some embodiments to provide a system and a method for using a decision-making model for coordination and collaboration among multiple agents in a multi-agent system. Additionally, or alternatively, it is an object of some embodiments to provide a multiagent decision-making model for collaboratively performing a task. Examples of agents include robots, allowing multi-robot collaboration, and may include a combination of robots and humans allowing human-robot collaborations. Examples of tasks include a factory automation process, such as assembly, manufacturing, sorting, and packing of various products. Additional examples of tasks include collaborative navigation, kitchen assistance, search and rescue, and safety operations by robotic and human agents, and the like.

Additionally, or alternatively, it is an object of some embodiments to provide a system for open multiagent decision-making collaboration forming an open control system. In contrast with a closed control system where agents are known, present, and subject to control at each and every control step, the open control system allows agents to enter and exit its control loop thereby allowing robots to be concurrently involved in several independent tasks and/or allowing humans to be distant from or join the execution of the task when needed. Doing so in such a manner can increase the productivity of many systems, such as factory automation systems.

In other words, it is an object of some embodiments to disclose a multi-agent system (MAS) with agent openness allowing the agents to join or leave the system dynamically, as well as to share or hide information with other agents. This concept is advantageous in scenarios where the system needs to adapt to changes in the environment, such as agents entering or exiting, or when agents need to collaborate while maintaining certain levels of privacy or security. Openness also allows the agents to move between various locations or platforms within the system. This mobility can be used to optimize resource usage or to facilitate communication and collaboration. In addition, the openness of the MAS allows its agents to cooperate and coordinate their actions to achieve common goals, even when they have different capabilities or objectives, which is beneficial for human-robot collaboration.

Providing control for the open MAS is challenging. Some embodiments are based on recognizing that multi-agent control can be addressed using a decentralized Markov decision process (Dec-MDP). The Dec-MDP is a probabilistic model that can consider uncertainty in outcomes, sensors, and communication or coordination and decision-making among multiple agents. The partial task view of each agent (perfectly observable by them) forms their local state. The set of local states of all agents forms the global state of the system. This variant of Dec-MDP is termed locally fully observable. However, Dec-MDP is not suitable for controlling open multi-agent systems. Specifically, in the Dec-MDP, at each time step, each agent takes an action, the state updates based on the transition function (using the current state, and the joint action or independent action of an agent), each agent observes an observation based on the observation function (using the next state and the actions) and a reward is generated for the whole team based on the common reward function. The action space for each agent might be different. Switching between teams might change the team composition and correspondingly the actions' set. Since Dec-MDP inherently is a closed system, the policy considers even agents absent from the task, which is inconsistent in context of open multi-agent systems.

To that end, it is an object of some embodiments to modify or adapt Dec-MDP for agent openness, referred to herein as oDec-MDP. The oDec-MDP adapts the Dec-MDP in at least two aspects. On one hand, the oDec-MDP changes the input and/or state space by introducing an additional input, i.e., a collaboration variable that indicates which team is currently active and by extension the agent composition. This variable is responsible for the size and attributes of the current task state of the oDec-MDP. For example, in one embodiment, the collaboration variable is implemented as a binary vector, where each element corresponds to a specific agent in the multi-agent system, and value one indicates that the corresponding agent is active, while value zero indicates that the agent is inactive. In another example, the collaboration variable can be implemented as a unique natural number assigned to a team of agents. The collaboration variable decides the currently active agents, their state attributes and size of the global state of the system, by forming the state as a combination of local states of active agents indicated by the collaboration variable. Thus, the oDec-MDP is locally fully observable. The latter approach can reduce the state space and simplify the computation. Also, the oDec-MDP introduces an additional action, i.e., “call_agentID.” This action commands one of the active agents to call an inactive agent for a task that the oDec-MDP policy decides to activate. For example, in the case of the robot, the call_agentID action can call the robot indicated by its ID using, for example, a radio signal. If the agent is a human, the call_agentID can lead to an audio/video signal to call the human agent by its ID. By including another action “exit_agent,” any active agent can decide to exit the task on their own volition at any time in the task. This way the team may transition to a different team, by deactivation of active agents. The collaboration variable's value changes upon the decision to activate or deactivate an agent. In other words, the actions are selected from types of actions including activation or deactivation actions calling for activating or deactivating a specific agent from the set of agents depending on the task.

The oDec-MDP can be trained with reinforcement learning (RL) in a manner similar to training the Dec-MDP. In addition, some embodiments employ a method for inverse reinforcement learning (IRL) that uses expert demonstrations to learn a reward function for solving open human-robot collaboration problems, with forward rollout RL training using the learned reward function. This approach is advantageous for complex tasks with intricate rewards that can be infeasible to manually define. One such complex domain is human-robot collaboration where both human and robotic agents need to factor each other's actions into their decision making. An additional challenge in open human-robot collaboration is the presence of multiple team assignments or action sequences leading to task completion. The solution of the training is a vector of policies (one for each active agent) that maps agent local states and collaboration variable to actions for the agents. IRL is a type of machine learning where an agent tries to learn the reward function of a task by observing the behavior of an expert. In traditional reinforcement learning, the agent learns a policy that maximizes the expected cumulative reward. However, in IRL, the goal is to infer the underlying reward function based on the observed behavior of an expert.

A decentralized adversarial IRL (Dec-AIRL) algorithm is used to solve Dec-MDP that learns a common reward function for the team, from expert demonstrations. Adversarial IRL uses a discriminator D_{θ} (X) to learn a function f_{θ} (X) which at convergence approximates the advantage function corresponding to the expert's policy. According to some embodiments, a decentralized generalization of Proximal Policy Optimization (Dec-PPO) is used as Dec-AIRL's forward-rollout technique. Dec-PPO uses the centralized training, decentralized execution paradigm where the centralized critic network updates its value function as a squared-error loss.

However, some embodiments adapt the IRL for open multi-agent systems. For example, in some embodiments of the present disclosure, an oDec-AIRL algorithm takes the oDec-MDP without the reward and transition functions; and the expert trajectories, as input to learn a common reward function, and its corresponding vector of learned policies. The discriminator D_{θ} (X) of oDec-AIRL learns a common reward function contingent on collaboration variable, state, and action space. This common reward function is then used by oDec-PPO to learn a vector of policies (one for each active agent). oDec-AIRL minimizes the reverse KL divergence between the learner's and expert's marginal collaboration variable state-action distribution.

According to some embodiments, a controller for controlling a collaboration of a set of agents jointly performing a task is provided. The set of agents includes at least one robot, and for at least some of different control steps, the set of agents includes different combinations of active agents and inactive agents defined by a collaboration variable. The controller includes circuitry configured to accept a feedback signal including observations of a state of execution of the task performed by the active agents from the set of agents specified by the collaboration variable. The circuitry is configured to process the observations with a neural network trained with machine learning to determine actions for the active agents specified by the collaboration variable. The actions are selected from types of actions including activation actions calling for activating or deactivating a specific agent from the set of agents. The collaboration variable is updated when the neural network outputs at least one activation action to update a combination of active agents and inactive agents and cause the active agents to execute the determined actions.

According to some other embodiments, a method for controlling a collaboration of a set of agents jointly performing a task is provided. The set of agents includes at least one robot. For at least some of the different control steps, the set of agents includes different combinations of active agents and inactive agents defined by a collaboration variable. The method comprises accepting a feedback signal including observations of a state of execution of the task performed by the active agents from the set of agents specified in the collaboration variable. The method comprises processing the observations with a neural network trained with machine learning to determine actions for the active agents specified in the collaboration variable. The actions are selected from types of actions including activation actions calling for activating or deactivating a specific agent from the set of agents. The method comprises updating the collaboration variable when the neural network outputs at least one activation action to update a combination of active agents and inactive agents and cause the active agents to execute the determined actions.

According to yet other embodiments, a non-transitory computer readable medium having stored thereon instructions that when executed by a computer, cause the computer to perform a method for controlling a collaboration of a set of agents jointly performing a task is provided. The set of agents includes at least one robot, such that for at least some of different control steps, the set of agents includes different combinations of active agents and inactive agents defined by a collaboration variable. The method comprises accepting a feedback signal including observations of a state of execution of the task performed by the active agents from the set of agents specified in the collaboration variable. The method comprises processing the observations with a neural network trained with machine learning to determine actions for the active agents specified in the collaboration variable. The actions are selected from types of actions including activation actions calling for activating or deactivating a specific agent from the set of agents. The method comprises updating the collaboration variable when the neural network outputs at least one activation action to update a combination of active agents and inactive agents and cause the active agents to execute the determined actions.

### BRIEF DESCRIPTON OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1 illustrates a system for controlling a collaboration among a set of agents jointly performing a task, according to an embodiment of the present disclosure;

FIG. 2 illustrates an example block diagram of system including a controller, in accordance with an embodiment of the present disclosure;

FIG. 3A illustrates a block diagram of an architecture of a neural network in communication with the controller, in accordance with an embodiment of the present disclosure;

FIG. 3B illustrates a schematic showing a state space as depicted by the variable of global state space, in accordance with an embodiment of the present disclosure;

FIG. 3C illustrates a schematic showing an example of implementation of the collaboration variable, in accordance with an embodiment of the present disclosure;

FIG. 3D illustrates an example of an action space implemented by the oDec-MDP, in accordance with an embodiment of the present disclosure;

FIG. 3E illustrates an example of generation of an activation signal, in accordance with an embodiment of the present disclosure;

FIG. 3F illustrates an example of invoking of an activation action by a currently active agent, in accordance with an embodiment of the present disclosure;

FIG. 3G illustrates another example of invoking of an activation action by a currently active agent, in accordance with an embodiment of the present disclosure;

FIG. 4 illustrates a schematic showing evolution of the oDec-MDP for two different control steps, in accordance with an embodiment of the present disclosure;

FIG. 5A illustrates a block diagram of a method for solving the oDec-MDP based on o-Dec-AIRL training methodology, in accordance with an embodiment of the present disclosure;

FIG. 5B illustrates an example of an algorithm that is used to implement the o-Dec-AIRL learning methodology by the neural network, in accordance with an embodiment of the present disclosure;

FIG. 6 illustrates a flow diagram of a method for controlling a collaboration of a set of agents jointly performing a task, in accordance with an embodiment of the present disclosure;

FIG. 7A illustrates a schematic of a robotic manipulator that may be controlled by the controller to perform a task collaboratively with a human, in accordance with an embodiment of the present disclosure;

FIG. 7B illustrates a schematic of an example task that requires human robot collaboration in accordance with an embodiment of the present disclosure;

FIG. 7C illustrates an example flow diagram of a method executed by the controller for performing a task collaboratively for table assembly, in accordance with an embodiment of the present disclosure;

FIG. 7D illustrates the method steps for the method of FIG. 7C that are executed when a human is called for assistance, in accordance with an embodiment of the present disclosure;

FIG. 8 illustrates graphical data showing performance data of the controller for executing the human robot collaborations tasks, in accordance with an embodiment of the present disclosure; and

FIG. 9 illustrates some components of controller for controlling a robotic manipulator according to a task, in accordance with an embodiment of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

With advancements in robotics and AI, there is an increasing prevalence of multi-agent systems including robots and humans. Such multi-agent systems, include the dyadic control systems based on collaboration between humans and robots for jointly performing a task, also referred to as HRC systems. The HRC systems based on AO, where any agent may enter and exit the task at any time, are referred to as the OHRCS.

Some embodiments of the present disclosure provide a multiagent decision-making framework for modeling open human robot collaborations in the OHRCS. Many human-robot collaboration domains involve only a small subset of activities that require multi-arm or dexterous manipulation, and hence do not need the presence of a human throughout the task. Thus, some embodiments provide for effective HRC methods that aim to effectively utilize different agents as and when required for a particular task, while also making the agents available concurrently for different tasks, thereby increasing the overall efficiency of the OHRCS. Further, some embodiments provide minimization of human agents' involvement and time in the task performed jointly by a robot and a human, thereby providing high levels of autonomy for the human involved in the task. Accordingly, the OHRCS leads to effective utilization of human agent in the HRC based task, where the monotonous and force-intensive tasks can be performed by the robot, while the cognitively demanding and dexterous manipulation tasks can be better conducted by humans.

Some embodiments disclose an OHRCS including a controller based on an oDec-MDP framework to model agent openness such that oDec-MDP includes a state space including a collaboration variable that indicates which of the agents is active or inactive in a team of a set of agents. In some embodiments of the present disclosure, the collaboration variable is a part of the state space indicating a state of the implementation of the task.

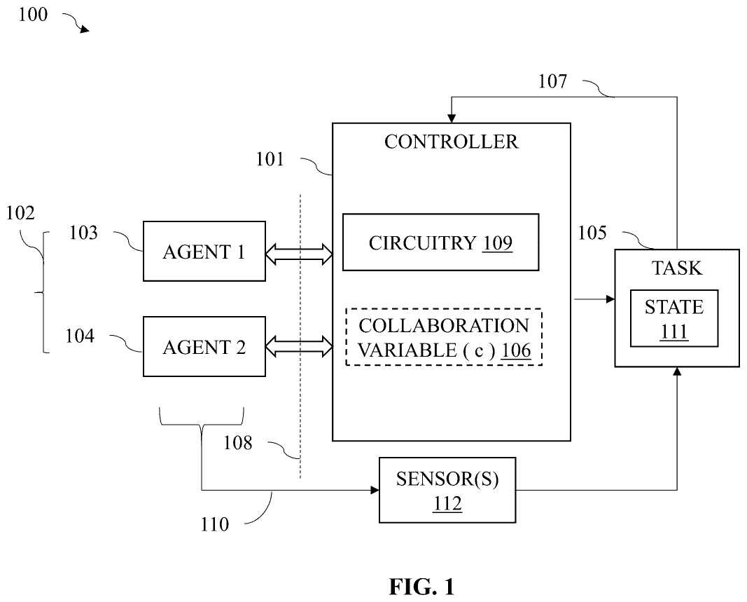

FIG. 1 illustrates a system 100 for controlling a collaboration among a set of agents 102 jointly performing a task 105, according to an embodiment of the present disclosure. The system 100 includes, as an example, two agents in the set of agents 102—an agent 103 and an agent 104. However,, it may be understood by one of ordinary skill in the art that any number of agents may equivalently form the set of agents 102, without deviating from the scope of the present disclosure. In the set of agents 102, at least one agent may be a robot. For example, the agent 103 may be a robot and the agent 104 may be any human or a robot. When the agent 104 is a human, the system 100 forms an HRC system. To that end, different agents in the set of agents 102 may work in collaboration for jointly performing the task 105.

The system 100 includes a controller 101 that is configured for controlling the collaboration of the set of agents 102 jointly performing the task 105. The task 105 may include any of a factory automation task, a rescue and recovery task, an assembly task, a navigation task, an embodied navigation task, a planning task, and the like. The set of agents 102 may operate jointly to perform the task 105, which may be any of a long horizon task or a short horizon task, and the task 105 may be performed in different control steps executing at different instants of time. For at least some of the different control steps, the set of agents 102 includes different combinations of active agents and inactive agents defined by a collaboration variable 106 (such as a variable c). For example, at a control step t, the agent 103 may be an active agent while the agent 104 may be an inactive agent. An agent is considered active when they are being controlled by the controller 101 for executing an action related to performance of the task 105. On the other hand,, an agent is considered inactive when their contribution is not required at that particular control step for execution of the task 105 and thus, the inactive agent is free to exit the task 105 for that particular control step.

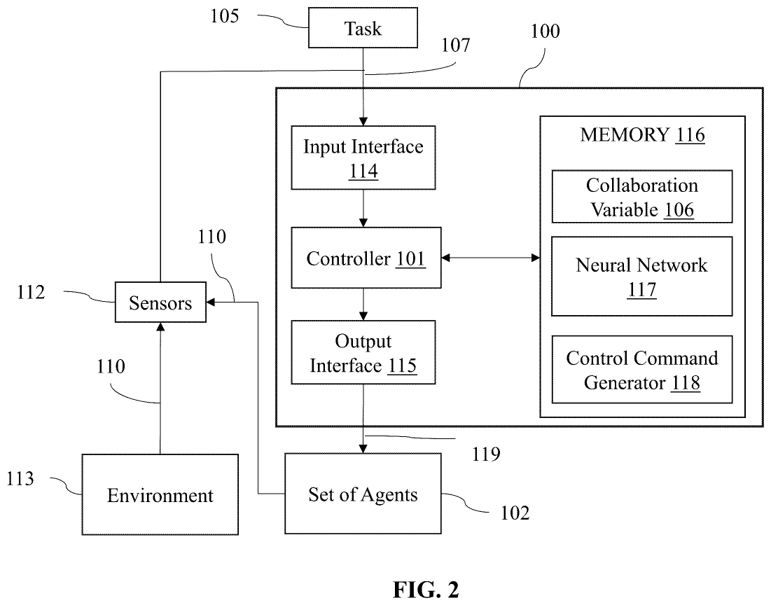

The controller 101 includes circuitry 109 configured to cause controlling of collaboration among different agents from the set of agents 102, which includes different combinations of the active agents and the inactive agents for different control steps. Circuitry 109 is further configured to accept a feedback signal 107 including observations 110 of a state of execution 111 of the task 105 performed by the active agents from the set of agents 102 specified by the collaboration variable 106. To that end, one or more sensors 112 may be configured to sense or observe an environment and the set of agents 102 to determine the state of execution 111 of the task 105. The circuitry 109 is further configured to process the observations 110 with a neural network (shown later in FIG. 2) trained with machine learning to determine actions 108 for the active agents specified by the collaboration variable 106, wherein the actions 108 are selected from types of actions including activation actions calling for activating or deactivating a specific agent from the set of agents 102. Further, once an action is executed, the circuitry 109 is configured to cause an update of the collaboration variable 106. In some embodiments, the update is performed when the neural network outputs at least one activation action to update a combination of the active agents and the inactive agents and cause the active agents to execute the determined actions 108. Each combination of the active agents and the inactive agents is one of the different combinations of active agents and inactive agents defined by the collaboration variable 106.

The circuitry 109 may be realized through and coupled with suitable processing, communicative, and computational circuitry that may be embodied within or coupled to the controller 101.

FIG. 2 illustrates an example detailed block diagram of the system 100 including the controller 101, in accordance with an embodiment of the present disclosure. The controller 101 processes input data received via an input interface 114 by invoking various modules stored in a memory 116. According to some embodiments, the task 105 may be an object assembling task such as furniture assembly and may be sub-divided into a plurality of sub-tasks, each achievable or realizable through a series of actions. The task 105 may correspond to connecting, coupling, or positioning a plurality of parts in a particular configuration. According to some embodiments, the task modelling considers each task as a combination of hierarchical skills and actions of those skills. The task 105 may be received (accepted) by the system 100 via the input interface 114. The system 100 further includes an output interface 115 through which one or more control commands may be sent to the set of agents 102 to control the set of agents 102 to cause execution of actions 108 required for performing the task 105. The controller 101 processes, using the circuitry 109 shown in FIG. 1, the input data received via the input interface 114 by invoking various modules stored in the memory 116. The modules stored in the memory 116 may include as an example, the collaboration variable 106, a neural network 117 trained with machine learning to process the observations 110 to determine the actions 108 for the active agents in the set of agents 102. To that end, the neural network 117 may accept the feedback signal 107 received by the input interface 114, where the feedback signal includes the observations 110 obtained by the one or more sensors 112. The observations are indicative of the state 111 of the execution of the task 105. Further, the neural network 117 communicates with a control command generator 118 to determine the actions 108 for the active agents in the set of agents 102.

According to some embodiments, the sensors 112 may comprise sensors for capturing the observations 110 in the form of observation for the set of agents 102 and/or its environment 113. For example, the set of agents 102 may include a robotic manipulator and the environment 113 is an assembly environment, so the observations may comprise multi-modal observations pertaining to the robotic manipulator and/or the assembly environment. According to some embodiments, the multi-modal observations include tactile, visual, and proprioceptive observations of the robotic manipulator and the assembly environment. For example, the multi-modal observations include measurements of one or more visuo-tactile sensors attached to the end effector of the robotic manipulator for tracking the motion of markers on the sensor, video frames of a camera observing the state of execution of the task 105 for a pose estimation of an object, and proprioceptive measurements of one or more actuators of the robotic manipulator.

In some embodiments, the system 100 operates in a feedback loop to generate a hierarchical output with output actions conditioned upon skills required to perform the task 105. That is, at each instance of time, the input observations are processed to predict an action conditioned upon a skill of the robotic manipulator. The action is translated into one or more control commands 119 by the control command generator and transmitted to the robotic manipulator via the output interface 115 to perform contact rich manipulation with real world objects to execute the assembly task. Each skill defines a combination of actions for the robotic manipulator. Upon execution of the commands, the state of the robotic manipulator and the objects in the assembly environment changes. Accordingly, the sensors 112 recapture the observations 110 and the processing is repeated until all the sub-tasks of the assembly task are executed. Thus, the input bundle is used to predict the target pose as the action for a current timestep. At each step, the inputs are aggregated to predict the state at the current timestep.

In some embodiments, the memory 116 may be configured to store a tokenizer module that encodes each of the observations 110 into an embedding of that observation in a latent space. For example, the tokenizer generates a proprioception embedding input, a visual signal embedding input, a contact information embedding input, a demonstrated action embedding input, and the like from the observations 110.

In some embodiments, the memory 116 stores neural network 117 which is based on an open decentralized Markov decision process (oDec-MDP).

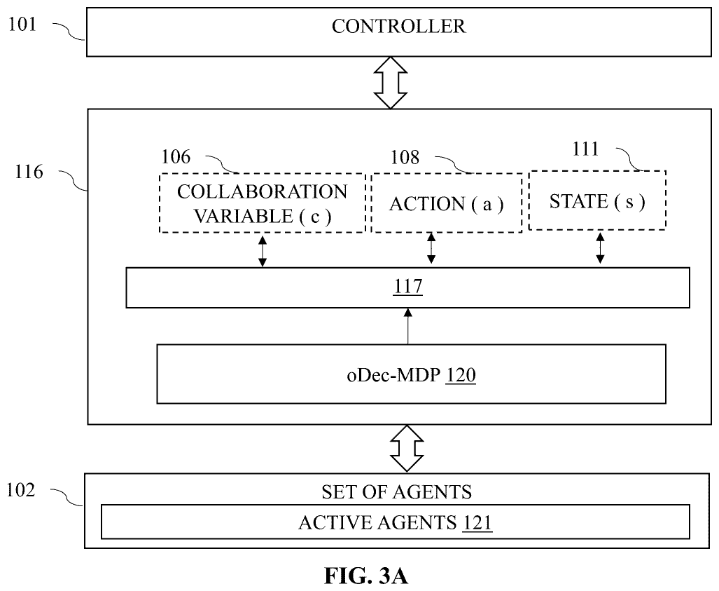

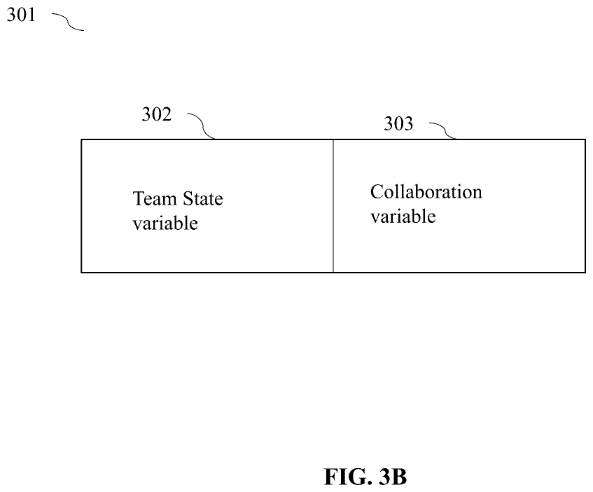

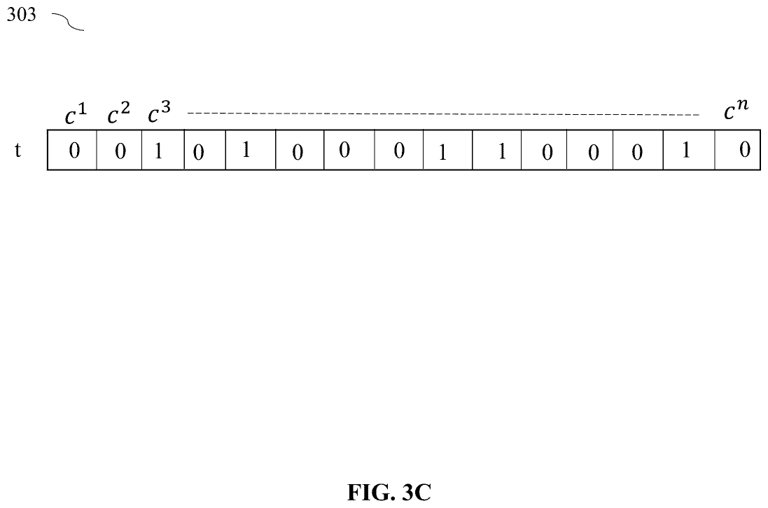

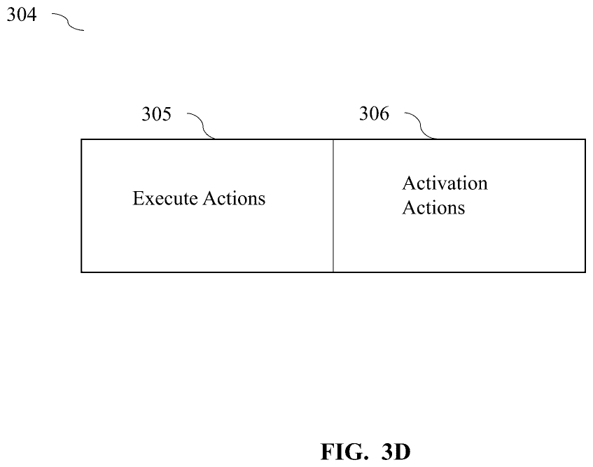

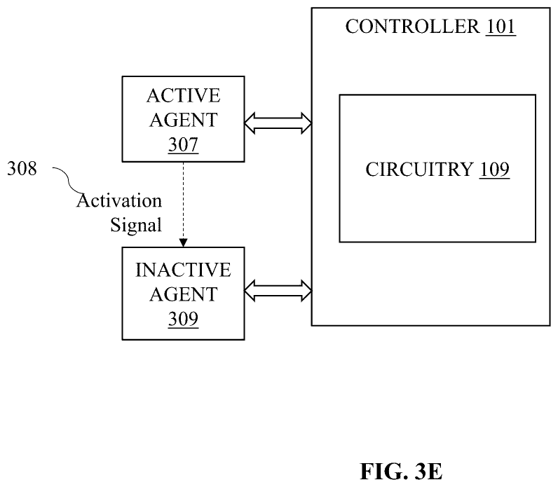

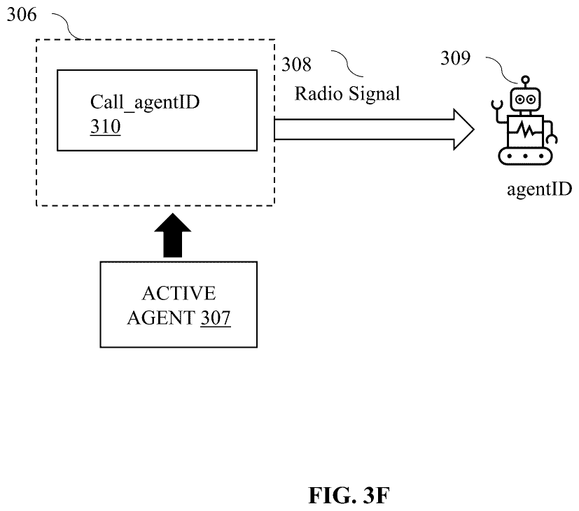

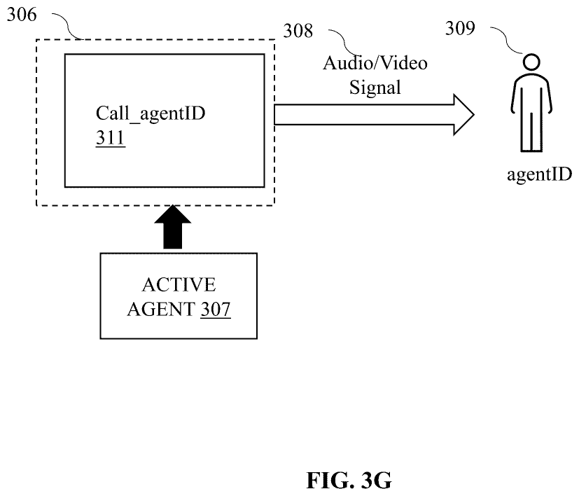

FIG. 3A illustrates a block diagram of an architecture of the neural network 117 in communication with the controller 101, according to some embodiments of the present disclosure. Neural network 117 includes one or more modules in the form of program instructions that solve an oDec-MDP 120.

The oDec-MDP 120 is a multiagent model that is used to model AO in HRC.

In some embodiments, the oDec-MDP 120 model is solved using the neural network 117 that is trained with reinforcement learning. In some embodiments, the oDec-MDP 120 model may be solved using an IRL methodology, such as oDec-AIRL to address OHRC problems. The oDec-MDP 120 model generalizes Dec-MDP to model agent openness in a decentralized, collaborative setting.

Formally, the oDec-MDP 120 model may be defined as:

$$oDec - MDP {=}^{△} 〈 Ag , C , S , A , Γ , T , R , ρ 〉 \qquad Eq . ( 1 )$$

where Ag is the finite set of all agents and |Ag|=N is the maximum number of agents, C: [symbol] (Ag)→ [symbol] assigns a unique number identifier to each collaborating team of the set of agents 102, and [symbol] denotes the powerset excluding the empty set. Further C denotes the set of all assigned identifiers corresponding to the collaboration variable 106. Collaborating team is defined by the subset of agents mapped to the current collaboration variable c∈C which may be a unique identifier natural number.

In an embodiment, the state 111 of the task 105 is defined by a global state space

$$S = {U}_{c = 1}^{c = \vert C \vert} {S}_{c}$$

where c∈C and S_{c} denotes the set of states of the team identified by c.

FIG. 3B illustrates a schematic showing a state space 301 as depicted by a variable of global state space S.

In an embodiment, the oDec-MDP 120 model adapts the Dec-MDP model by changing the input to the controller 101. The input comprises the state 111 of the task, which is selected from the state space 301. The state space 301 is formed as a combination of two variables—a team state variable 302, which may be equivalent to the normal state of the task 105 of the active agents, and an additional input, i.e., a collaboration variable 303 (equivalent to the collaboration variable 106 disclosed previously) that indicates which of the agents is active or inactive in a team of agents selected from the set of agents 102.

In some embodiments, the collaboration variable 303 is part of the state 111 of the implementation of the task 105 defined by the oDec-MDP 120 model.

FIG. 3C illustrates a schematic showing an example of implementation of the collaboration variable 303, in accordance with an embodiment of the present

MERL. MANY disclosure. In the example embodiment of FIG. 3C, the collaboration variable 303 is shown for a control step t. The collaboration variable 303 is implemented as a binary vector having elements where each element corresponds to a specific agent in the set of agents 102. For example, an element c¹ corresponds to an agent 1, an element c² corresponds to an agent 2, an element c³ corresponds to an agent 3, and an element cⁿ corresponds to an agent n, where agent 1, agent 2, agent 3, and agent n are part of the set of agents 102. It may be understood that any of these agents may be a robot or a human and at any time any combination of agents may be active, without deviating from the scope of the present disclosure.

For each of the elements of the collaboration variable 303, value one indicates that the corresponding agent is active, while value zero indicates that the agent is inactive. For example, for FIG. 3C, at the control step t, c¹, c², and cⁿ are having a value ‘0’ which indicates that the agent 1, agent 2, and agent n are inactive at the control step t. Therefore, they may be allowed to exit the task 105 and may be utilized for performing some other tasks. This flexibility provided by the controller 101 through the implementation of the collaboration variable 303 is advantageous in increasing the overall efficiency of task performance and utilization of the agents in the system 100. This also makes the system 100 open and collaborative and helps implement true AO.

Referring again to FIG. 3C, at the control step t, c³ is having a value ‘1’ which indicates that the agent 3 is active and is being utilized in the execution of the task 105.

In another example, the collaboration variable 303 can be implemented as a unique identifier natural number assigned to a team of agents. For example, the collaboration variable 303 may correspond to an ID, called team ID, for a team of agents selected from the set of agents 102. The team ID may have any value such as 1, 2, 3, 4, and the like from the set of natural numbers.

In the example embodiment of FIG. 3B, the collaboration variable 303 is part of the state directly, by modifying the state space 301. In some embodiments, the collaboration variable 303 may be part of the state space 301 indirectly by forming the state as a combination of states of active agents indicated in the collaboration variable 303. In this embodiment, the size of the state space 301 is reduced and this leads to simplification of the computations involved in the execution of the task 105.

Referring again to FIG. 1, in an embodiment, the actions 108 may be defined by a global action space

$$A = {U}_{c = 1}^{c = \vert C \vert} {A}_{c}$$

where c∈C and A_{c} denotes the set of joint actions of the team of agents identified by c. For instance, if team c involves agents i and j whose action sets are Aᵢ and Aⱼ, respectively, then A_{c}=Aᵢ×Aⱼ.

In some embodiments, the oDec-MDP 120 model changes the action space of the Dec-MDP to form the global action space A by introducing an additional action, i.e., “call_agentID.”

FIG. 3D illustrates an example of an action space 304 implemented by the oDec-MDP 120 model, according to an embodiment of the present disclosure. The actions 108 may be selected from the action space 304, and the action space 304 may correspond to the global action space A disclosed above. The action space 304 may include execute actions 305, and activation actions 306, for an example. The execute actions 305 may be equivalent to the normal action commands required for execution of the task 105, such as the actions that are known for Dec-MDP.

The activation actions 306 may correspond to additional type of action commands that are executed by one of the active agents to call an inactive agent for a task that the oDec-MDP 120 policy decides to activate. For example, in the case of the required agent being the robot, the call_agentID action can call the robot indicated by its ID using an activation signal. Further, if an active agent wants to call a human for assistance during the task, the call_agentID action causes sending of the activation signal to the human with that ID.

In some embodiments, the action space 304 also includes another type of action, called an “exit_agent” action, which may be executed by any active agent, if that active agent decides to exit the task on their own volition at any time in the task. This way the team or the combination of the active agents and the inactive agents may transition to a different team, by deactivation of active agents. The collaboration variable's value changes upon the decision to activate or deactivate an agent.

In some embodiments, the action space 304 includes deactivation actions calling for deactivating a specific agent from the set of agents 102 depending on the task 105.

FIG. 3E illustrates an example of generation of an activation signal 308, according to an embodiment of the present disclosure. To that end, the circuitry 109 of the controller 101 causes generation of the activation signal 308 that causes a currently active agent 307 to activate a currently inactive agent 309. For example, the currently active agent 307 may be a robot, which may send the activation signal by invoking the call_agentID command from the activation actions 306 of the action space 304. The active agent 307 may be one of the active agents 121 disclosed earlier in conjunction with FIG. 3A.

FIG. 3F illustrates an example of invoking of an activation action by a currently active agent, according to an embodiment of the present disclosure. The currently active agent 307 is a currently active robot and the currently inactive agent 309 is a currently inactive robot. Thus, the currently active robot invokes the activation action 306 which causes generation of the call_agentID command 310, where agentID is the identifier for the currently inactive agent 309, i.e., the currently inactive robot. As a consequence of the generation of the call_agentID command 310, the activation signal 308 is submitted from the currently active agent 307 to the currently inactive agent 309. The activation signal 308 is a radio signal, which may be received by a receiver at the currently inactive agent 309, i.e., the currently inactive robot. Thus, the currently inactive robot becomes active and joins the task 105. Further, the collaboration variable 303 may be updated to indicate the change of status of the currently inactive agent 309 from inactive to active.

FIG. 3G illustrates another example of invoking of an activation action by a currently active agent, according to an embodiment of the present disclosure. The currently active agent 307 is a currently active robot and the currently inactive agent 309 is a currently inactive human. Thus, the currently active robot invokes the activation action 306 which causes generation of the call_agentID command 310, where agentID is the identifier for the currently inactive agent 309, i.e., the currently inactive human. As a consequence of the generation of the call_agentID command 310, the activation signal 308 is submitted from the currently active agent 307 to the currently inactive agent 309. In an embodiment, the activation signal 308 is an audio signal, such as an alert sound, aa alarm sound, a ringtone sound, a speech, an audio call sent to the human agent's user device, and the like. In another embodiment, the activation signal is a video signal, such as a video call sent to the human agent's user device, a video message, and the like. The activation signal 308 may be received by a receiver of the currently inactive agent 309, i.e., the currently inactive human. Thus, the currently inactive human becomes active and joins the task 105. Further, the collaboration variable 303 may be updated to indicate the change of status of the currently inactive agent 309 from inactive to active.

Thus, as the collaboration variable 303 is part of the state space 301, its value changes upon the decision to activate or deactivate an agent. In other words, the actions 108 are selected from types of actions including the activation actions 306 calling for activating or deactivating a specific agent from the set of agents 102 depending on the task 105.

To that end, the neural network 117, which solves the oDec-MDP 120 model (as shown in conjunction with FIG. 3A), outputs at least one activation action 306 to update a combination of active and inactive agents from the set of agents and cause the active agents to execute the determined actions. As a result, the controller 101 causes an update of the collaboration variable 303 (equivalent to the collaboration variable 106 shown in FIG. 3A). For example, referring to FIG. 3C, if the agent 3 is no longer needed to contribute to the task 105, the neural network 117 causes output of the activation signal 308 to deactivate the agent 3. As a result, the value of the element c³ is changed from “1” to “0”, and overall, the collaboration variable 303 is updated. In another example, referring to FIG. 3C, if the agent 2 is needed to contribute to the task 105, the neural network 117 causes output of the activation signal 308 to activate the agent 2. As a result, the value of the element c³ is changed from “0” to “1”, and overall, the collaboration variable 303 is updated.

In an embodiment, the size of the binary vector corresponding to the collaboration variable 303 is equal to the size of the set of agents 102. For example, if the set of agents 102, includes 10 agents, then the collaboration variable 303 includes 10 elements, c¹ to c¹⁰.

In an embodiment, the state 111 of execution of the task 105 is multiplied by the binary vector corresponding to the collaboration variable 303 before submission to the neural network 117 to determine the corresponding actions 108.

Referring again to FIG. 1, in an embodiment, referring to Eq. (1), a team transition model Γ: C×A×C→[0, 1] gives the distribution of the new teams given the current team and action letting agent(s) enter or exit a task as required.

In an embodiment, referring to Eq. (1),

$$T = \{ {T}_{c} , {T}_{c}^{′} \vert c = 1 , 2 , … , \vert C \vert \} ,$$

where intra-team state transition model T_{c}: S_{c}×A_{c}×S_{c}→[0,1] gives the distribution over the team's next state, and inter-team state transition model.

$${T}_{c}^{′} : {S}_{c} \times {C}^{′} \times {S}_{{c}^{′}} , \to [ 0 , 1 ]$$

gives the distribution over the next team and its state. Both are available for all c,c′∈C.

In an embodiment, referring to Eq. (1), R_{c} is the common reward function shared by all agents in each team c, R_{c}≙R(S_{c}, A_{c}, c) and R_{c}: S_{c}×A_{c}→ [symbol] .

In an embodiment, referring to Eq. (1), the start state and team prior distribution ρ: S×C→[0,1].

In an embodiment, the collaboration between different agents in the set of agents 102 is modeled using the oDec-MDP 120 framework, using the collaboration variable 106, and an open teamwork trajectory of length [symbol] that contains the collaborating team ID, team state, and team action at each time step as per Eq. (2) as:

$${X}^{E} {=}^{Δ} ( c , {s}_{c} , {a}_{c} {1}^{} , c , {s}_{c} , {a}_{c} {2}^{} , {c}^{′} , {s}_{{c}^{′}} , {a}_{{c}^{′}} {3}^{} … {c}^{″} , {s}_{{c}^{″}} , {a}_{{c}^{″}} {}^{} ) . \qquad Eq . ( 2 )$$

In some embodiments, it is observed from the trajectory that the starting team with ID c persists for the first two control steps followed by a change to team c′. If the team with ID c at control step t=1 is a dyad with agents i and j, then the policy π, the team state

$${s}_{c}^{t}$$

and team action state

$${a}_{c}^{t}$$

vectors of the two murvidual agents' policies, their partial views (local states), and their actions respectively.

To that end, the team with ID c may include active agents 121 from the set of agents 102 for a given control step. Also, the team state

$${s}_{c}^{t}$$

may correspond to the observations of the state 111 of the execution of task 105 at control step t. Further, the team action

$${a}_{c}^{t}$$

may correspond to the actions 108 at the control step t for the active agents from the set of agents 102. To that end, the agents i and j, may correspond to the active agents from the set of agents 102, as specified by the collaboration variable 106 defined by Eq. (2) above.

In some embodiments, the overall policy for the team with ID c is thus given as π_{c}:

$${π}_{c} {=}^{Δ} {π}_{i} , {π}_{j} ; {s}_{c}^{t} {=}^{Δ} {s}_{i}^{t} , {s}_{j}^{t} ; and {a}_{c}^{t} {=}^{Δ} {a}_{i}^{t} , {a}_{i}^{t} . \qquad Eq . ( 3 )$$

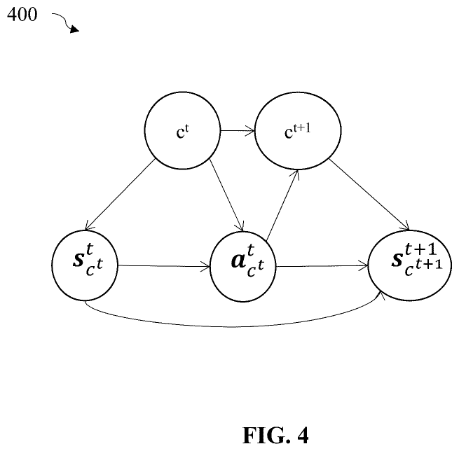

FIG. 4 illustrates a schematic 400 showing evolution of the oDec-MDP 120 model for two different control steps t and t+1, according to an embodiment of the present disclosure. A collaboration team at a given control step comprises a subset of active agents, such as the active agents 121 shown in FIG. 3A, from the set of agents 102 that engage in execution of the task at the given control step. Each collaboration team is identified by the collaboration variable 106, which may be referred to as the collab team ID c^{t} at the given control step. For example, if the given control step is at time t,

$${s}_{{c}^{t}}^{t}$$

denotes the state or ine conab team with ID c^{t}, and is formed by combining the local states of all agents in c^{t}. All agents' local actions from c^{t} are combined from

$${a}_{{c}^{t}}^{t} ,$$

which leads to c^{t+1},, given c^{t}·c^{t+1},

$${a}_{{c}^{t}}^{t} , {s}_{{c}^{t}}^{t}$$

together lead to the next state

$${s}_{{c}^{t + 1}}^{t + 1}$$

at control step at time t+1.

In some embodiments, the oDec-MDP 120 model is trained using reinforcement learning (RL). RL is a learning methodology that is based on the paradigm of taking actions by an intelligent agent in an environment, with an objective of maximizing a cumulative reward which is defined by a reward function. The environment is modeled using an MDP, such as the oDec-MDP 120 described above. The maximization of the reward function is accomplished by the agent learning a policy, such as the policy Itc described in Eq. (2) above.

In some embodiments, the oDec-MDP 120 model is trained using inverse reinforcement learning (IRL). To that end, the process of IRL typically involves: (1) observing an expert behavior: The agent observes the expert's actions in the environment, (2) inferring the reward function: Using the observed behavior, the agent tries to infer the reward function that the expert is likely optimizing, (3) learning a policy: Once the reward function is inferred, the agent can use it to learn a policy to reflect the expert's underlying preferences. IRL is useful in cases where it is difficult to manually design a reward function, or when the reward function is implicit and not directly observable.

In some embodiments, the expert's behavior is modeled using an expert trajectory, such as the trajectory XE described in Eq. (1) above.

The likelihood of the first two-time steps of the trajectory X^{E} is obtained using the parameters of the oDec-MDP 120 as:

$$Pr ( c , {s}_{c}^{1} , {a}_{c}^{1} , c , {s}_{c}^{2} , {a}_{c}^{2} ) = Pr ( c , {s}_{c}^{2} , {a}_{c}^{2} \vert c , {s}_{c}^{1} , {a}_{c}^{1} ) Pr ( c , {s}_{c}^{1} , {a}_{c}^{1} )$$

Which may further give:

$$Pr ( c , {s}_{c}^{1} , {a}_{c}^{1} , c , {s}_{c}^{2} , {a}_{c}^{2} ) = {π}_{i} ( {a}_{i}^{2} \vert c , {s}_{i}^{2} ) {π}_{j} ( {a}_{j}^{2} \vert c , {s}_{j}^{2} ) Γ ( c , {a}_{c}^{1} , c ) {T}_{c} ( {s}_{c}^{1} , {a}_{c}^{1} , {s}_{c}^{2} ) \times {π}_{i} ( {a}_{i}^{1} \vert c , {s}_{i}^{1} ) {π}_{j} ( {a}_{j}^{1} \vert c , {s}_{j}^{1} ) ρ ( c , {s}_{c}^{1} ) \qquad Eq . ( 4 )$$

Where,

$${π}_{i} ( {a}_{i}^{2} \vert c , {s}_{i}^{2} ) :$$

policy of i at t=2

$${π}_{j} ( {a}_{j}^{2} \vert c , {s}_{j}^{2} ) :$$

policy of j at t=2

$$Γ ( c , {a}_{c}^{1} , c ) :$$

team transition

$${T}_{c} ( {s}_{c}^{1} , {a}_{c}^{1} , {s}_{c}^{2} ) :$$

intra-team state transition

$${π}_{i} ( {a}_{i}^{1} \vert c , {s}_{i}^{1} ) :$$

policy of i at t=1

$${π}_{j} ( {a}_{j}^{1} \vert c , {s}_{j}^{1} ) :$$

policy of j at t=1

$$ρ ( c , {s}_{c}^{1} ) :$$

A locally fully observable Dec-MDP lets each agent's policy condition its action on the agent's partial view of the state.

For the oDec-MDP 120 described above, the likelihood obtained for the second-and third-time steps of the trajectory X^{E} when the team changes may be given as:

$$P r ( c , {s}_{c}^{2} , {a}_{c}^{2} , {c}^{′} , {s}_{{c}^{′}}^{3} , {a}_{{c}^{′}}^{3} ) = {π}_{i} ( {a}_{i}^{3} \vert {c}^{′} , {s}_{i}^{3} ) {π}_{j} ( {a}_{j}^{3} \vert {c}^{′} , {s}_{j}^{3} ) Γ ( c , {a}_{c}^{2} , {c}^{′} ) {T}_{{c}^{′}} ( {s}_{c}^{2} , {c}^{′} , {s}_{c}^{3} ) \times {π}_{i} ( {a}_{i}^{2} \vert c , {s}_{i}^{2} ) {π}_{j} ( {a}_{j}^{2} \vert c , {s}_{j}^{2} ) ρ ( c , {s}_{c}^{2} ) \qquad Eq . ( 5 )$$

The key difference between Eqs. 4 and 5 is that the latter involves the inter-team transition function T′_{c} due to the change of team from time step t=2 to t=3.

The value function of the oDec-MDP 120 may be given as:

$$V ( {s}_{c}^{t} ) = {max}_{{a}_{c}^{t}} {𝔼}_{{C}^{′} , {s}_{{c}^{′}}^{t + 1}} [ R ( {s}_{c}^{t} , {a}_{c}^{t} , c ) + γ V ( {s}_{{c}^{′}}^{t + 1} ) \vert {s}_{c}^{t} , c ] = {max}_{{a}_{c}^{t}} R ( {s}_{c}^{t} , {a}_{c}^{t} , c ) + γ {\sum }_{{C}^{′}} {\sum }_{{s}_{{c}^{′}}} , Pr ( {c}^{′} , {s}_{c}^{t + 1} \vert c , {s}_{c}^{t} , {a}_{c}^{t} ) \times V ( {s}_{{c}^{′}}^{t + 1} ) = {max}_{{a}_{c}^{t}} {R}_{c} + γ {\sum }_{{C}^{′}} {\sum }_{{s}_{{c}^{′}}} , Γ ( c , {a}_{c}^{t} , {c}^{′} ) {T}_{c}^{′} ( {s}_{c}^{t} , {c}^{′} , {s}_{c}^{t + 1} ) V ( {s}_{{c}^{′}}^{t + 1} )$$

Using the value function and trajectory derivations described above, the oDec-MDP 120 may be solved using both RL methodologies, and IRL.

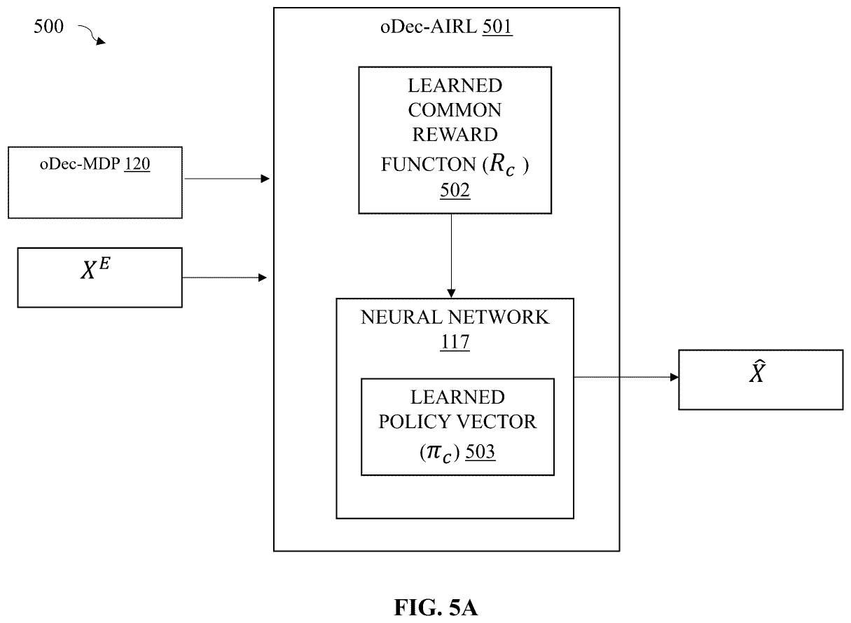

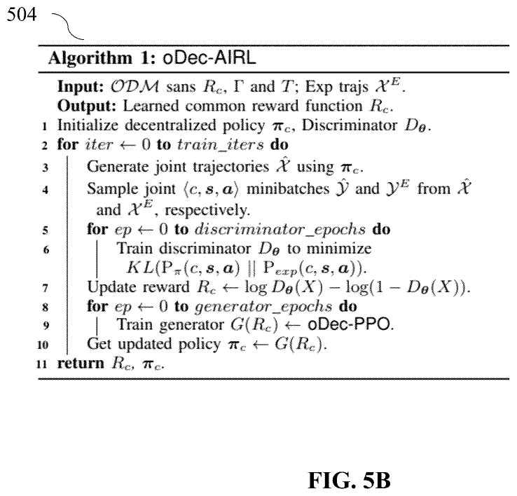

FIG. 5A illustrates a block diagram of a method for training a policy implemented by the neural network 117 for solving the oDec-MDP 120 using IRL, according to an embodiment of the present disclosure.

oDec-Adversarial Inverse Reinforcement Learning (oDec-AIRL) 501 is an IRL technique that models the task 105 using an oDec-MDP model, such as the oDec-MDP 120 model (sans reward and transition functions). The oDec-AIRL 501 solves the oDec-MDP 120 using common reward function R_{c} 502 to obtain current policies of a learned policy vector π_{c} 503 which are represented by the neural network 117 and uses the current learned policy vector π_{c} 503 to obtain sampled trajectories \hat{X}. Based on the sampled trajectories and the input expert trajectories X^{E}, the oDec-AIRL 501 updates its reward function R_{c}.

HRC tasks where only a subset of tasks require collaboration with a human can be formulated as OHRC problems. Considering how humans possess limited time and energy, the neural network 117 solving the oDec-MDP 120 model is used to solve the OHRC problem, allowing humans to effortlessly join and collaborate with robots when their assistance is needed. To that end, the controller 101 including the neural network 117 forms an open-adversarial HRC system (OHRCS) which uses the oDec-MDP 120 model as a multiagent decision making framework to model agent openness in OHRCS. Further, the o-Dec-AIRL 501 learning methodology is used to learn the underlying reward function R_{c} 502 and its corresponding learned policy vector π_{c} 503 policies using the oDec-MDP 120 as the behavioral model.

Further, the collaboration variable is updated according to oDec-MDP 120 model.

To that end, FIG. 5B illustrates an example of an algorithm 504 that is used to implement the o-Dec-AIRL 501 learning methodology, in accordance with an embodiment of the present disclosure.

For algorithm 504, the common reward function R_{c} is learned using inverse reinforcement learning contingent of the collaboration variable 106, c, a state space s, and an action space a.

To that end, a discriminator D_{θ} (X) of oDec-AIRL 501 learns the common reward function R_{c} contingent on c, s, and a. This common reward function is then used by oDec-PPO to learn a vector of policies (one for each agent). The oDecAIRL 501 minimizes the reverse KL divergence between the learner's and expert's marginal teamID-state-action distribution KL(P_{π}(c, s, a)∥Pₑₓₚ(c, s, a).

The algorithm 504 takes the oDec-MDP ( [symbol] [symbol] [symbol] ) without the reward and transition functions, and the expert trajectories X^{E} as input. The goal is to learn a common reward function R_{c} for the task 105 that best explains the behavior seen in X^{E}, and the corresponding vector of learned policies.

Algorithm 504 begins, at line 1, by initializing a random decentralized policy vector π_{c}, and a discriminator D_{θ} with random weights θ. Learning continues until the end of training iterations at line 2. In every iteration, the algorithm 504 generates, at line 3, joint trajectories \hat{X} of the agents (such as the set of agents 102) using the current policy vector π_{c}. Further, at line 4, minibatches of [symbol] c, s, a [symbol] are sampled from \hat{X} and X^{E} to yield Ŷ and YErespectively. Further, for different control steps or epochs at line 5, the algorithm 504 includes, at line 6, training the D_{θ} using Ŷ and Y^{E} to minimize the reverse KL divergence between the expert and learned distributions. Using the D_{θ}'s confusion, at line 7, an updated reward R_{c} is extracted. This reward function R_{c} is then provided as an input to train, at line 9, the generator G (R_{c}) using oDec-PPO which learns the forward rollout vector of policies at line 10. oDec-PPO is a generalized version of Dec-PPO that conditions its policy both on the state and collaboration variable. Finally, at line 11, the learned reward function R_{c} and converged policy vector π_{c} are returned.

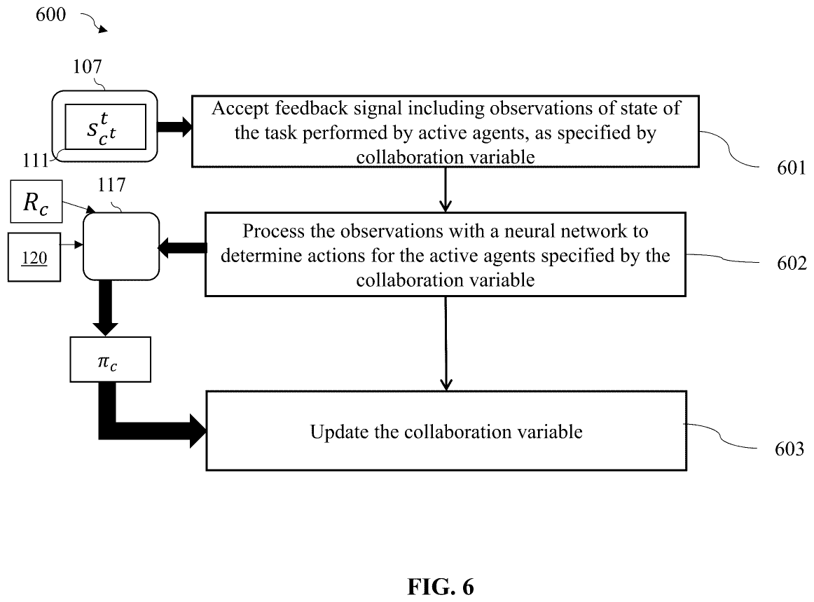

FIG. 6 illustrates a flow diagram of a method 600 for controlling a collaboration of a set of agents jointly performing a task, according to an embodiment of the present disclosure. For example, the task may be a human-robot collaboration task, such as the task 105. The set of agents may comprise at least one robot. For example, the set of agents 102 may comprise at least one robot. The robot may correspond to a robotic manipulator which receives control commands from the controller 101. To that end, the controller 101 includes the circuitry 109 which may implement the method 600. In an embodiment, the method 600 is executed by the neural network 117 at inference time.

The controller 101 accepts 601 the feedback signal including observations of a state of the task for at least some of the different control steps. According to some embodiments, the feedback signal may be provided in a time-continuous manner or discrete manner. Alternately, in some embodiments, the feedback signal may be provided on demand, for example, after an action has been executed. For example, the controller 101 accepts the feedback signal 107 including observations 110 of a state of execution 111 of the task 105 performed by the active agents from the set of agents 102 specified in the collaboration variable 106. The state of the active agents may be defined by the variable

$${s}_{{c}^{t}}^{t}$$

for a given control step at time t. As discussed earlier in conjunction with FIG. 3A, FIG. 3B, FIG. 3C, and FIG. 4, the set of agents 102 includes different combinations of active agents and inactive agents defined by the collaboration variable 106.

The method 600 includes the controller 101 configured to process 602 the observations with a neural network trained with machine learning to determine actions for the active agents specified in the collaboration variable, wherein the actions are selected from types of actions including activation actions calling for activating or deactivating a specific agent from the set of agents. For example, the observations of the state,

$${s}_{{c}^{t}}^{t} ,$$

of the active agents 121 from the set of agents 102 are passed to the neural network 117. The neural network 117 outputs actions for currently active agents based on the learned policy π_{c} for a given control step t. The learned policy π_{c} defines the set of actions to be taken at the current control step, such as actions

$${a}_{{c}^{t}}^{t}$$

discussed in the FIG. 4. As a result of execution of the actions

$${a}_{{c}^{t}}^{t} ,$$

the overall state of the set of agents 102 is changed. As discussed in conjunction with FIG. 3D, the actions

$${a}_{{c}^{t}}^{t}$$

may be selected from me action space 304 which includes the execute actions 305, and the activation actions 306.

Further, method 600 comprises operations for the controller 101 configured to update 603 the collaboration variable when the neural network outputs at least one activation action to update a combination of active and inactive agents and cause the active agents to execute the determined actions. After execution of the actions, for the next control step t+1, the collaboration variable may be updated to c^{t+1} and the state of the current team of agents 102 may be updated to

$${s}_{{c}^{t + 1}}^{t + 1} .$$

It may be understood that steps of the method 600 from block 601 to block 603 may be executed iteratively until the task 105 is completed.

In some embodiments, the set of agents 102 comprises a human and a robotic manipulator and the task 105 is a collaborative assembly task.

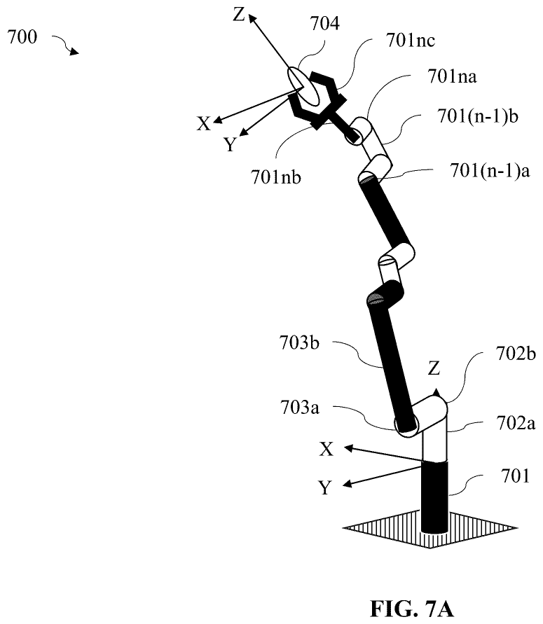

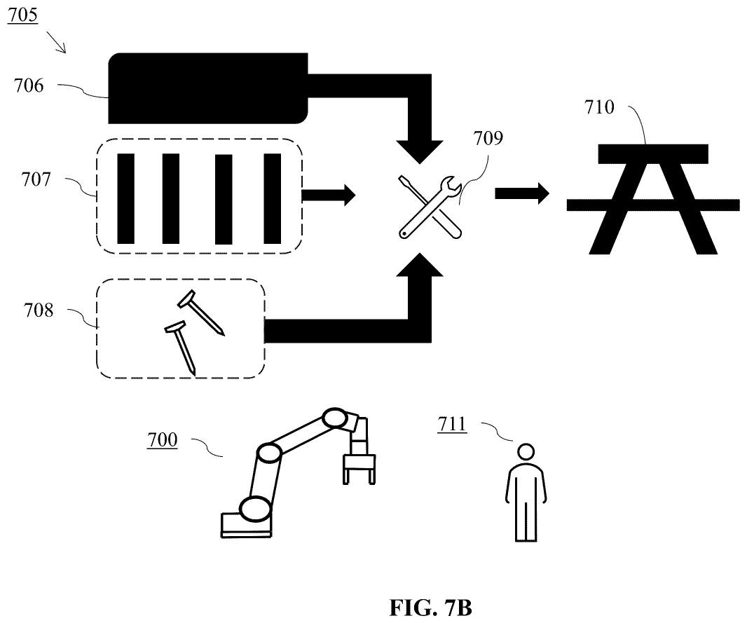

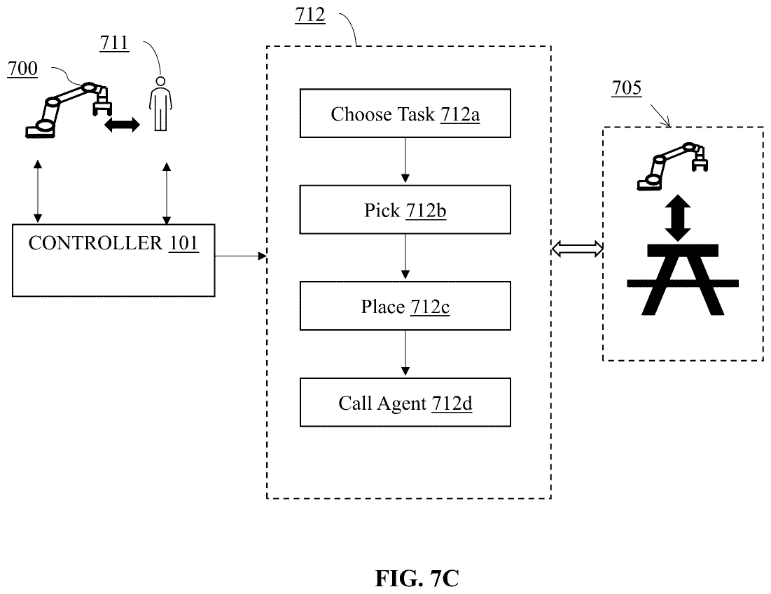

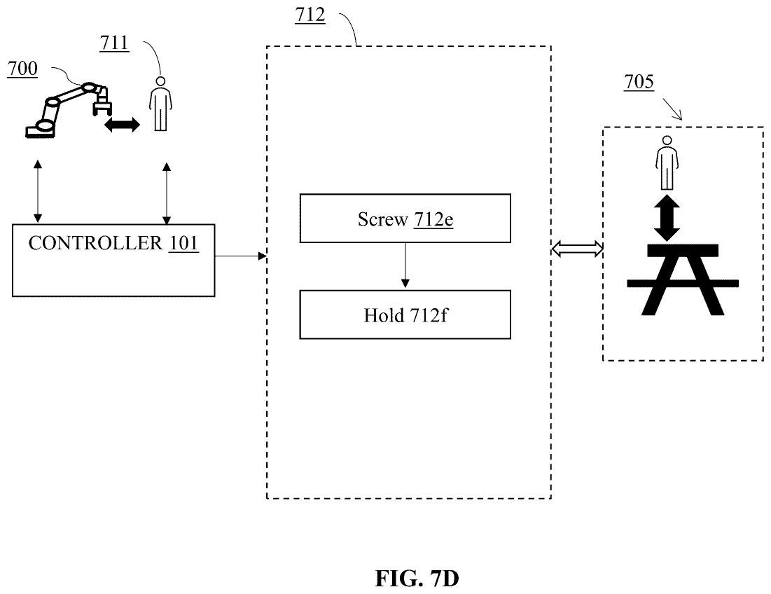

FIG. 7A illustrates a schematic of a robotic manipulator 700 that may be controlled by the controller 101 to perform a task collaboratively with a human, in accordance with an example embodiment.

In an embodiment, the robotic manipulator 700 is used to perform task 105 corresponding to an object assembly. The robotic manipulator 700 may be an n degree-of-freedom (DOF) open-chain manipulator. The robotic manipulator 700 comprises a base 701, multiple joints, multiple links, and an end-effector 701nc where each joint may typically move in one or more directions. The robotic manipulator 700 may be used to perform one or more tasks such as manipulating one or more payloads such as an object 704. The specific task may be defined in terms of parameters including, e.g., an initial position and velocity of the object 704, a final position and velocity of the object 704, acceleration and velocity constraints on the object 704, time to accomplish the task, a start pose of the object 704, a goal pose of the object 704, and the like. The robotic manipulator 700 may be electronically coupled to a control system such as system 100 of FIG. 1 and FIG. 2, that includes the controller 101 that provides control inputs/commands to execute the task. An interface may be utilized to receive or collect one or more tasks. According to some embodiments, base 701 may be mountable on a surface such as the floor or a movable platform. The other end of the base 701 may be mechanically coupled with a first-axis link 702b through a first-axis joint 702a. The first-axis link 702b is coupled with a second-axis joint 703a, which is connected to a second-axis link 703b. This coupling and connection patterns are repeated until reaching the end-effector 701nc, which is attached on a last-axis link 701nb. The last-axis link 701nb is coupled with a previous link 701(n-1)b through a last-axis joint 701na. According to some embodiments, one or more components of the robotic manipulator 700 may be modeled in any suitable manner such as in terms of mathematical equations and a corresponding model of the components may be accessible to the control system of the robotic manipulator 700. Each such model may describe interaction between various variables pertaining to the corresponding component such as control input variables, state variables (for example position, orientation, heading etc.).

In some embodiments, a joint of the robotic manipulator 700 may be of any suitable type including but not limited to: revolute, prismatic, helical etc. The movements of the joints of the robotic manipulator 700 may be controlled by one or more actuators coupled to the joints such that the robotic manipulator 700 can be moved in accordance with one or more control inputs to effectuate manipulation of the payload 704 along any dimension.

The controller 101 may be configured for controlling the robotic manipulator 700 according to the task 105, in accordance with some example embodiments. The feedback signal 107 including observations 110 of a state of execution of the task performed by the robotic manipulator 700 is received/accepted by the controller 101 at each control step of time when the robotic manipulator 700 is active and involved in performance of the task. The status of the robotic manipulator 700, whether active or inactive, is specified by the collaboration variable 106 vector (as specified in FIG. 3C). The controller 101 transforms the observations into embeddings in a latent space, such as by invoking the circuitry 109 shown in FIG. 1.

The embeddings of the observations together with the common reward function R_{c} are processed by the neural network 117 at each control step of time. The neural network 117 is trained to output actions 108 for the robotic manipulator 700 based on the learned vector of policies It and the common reward function R_{c}.

To that end, the control command generator 118 shown in FIG. 2 may be invoked by the controller 101 to generate one or more control commands based on the produced actions 108. In this regard, the control command generator 118 may reference a stored table that maps actions with corresponding control commands. According to some embodiments, the control command generator 118 may dynamically generate the control commands for executing the produced action based on the state information of the robotic manipulator 700 and the objects in the environment 113. The controller 101 outputs the generated control commands to one or more actuators of the robotic manipulator 700 to control the robotic manipulator 700, for example by causing a change of the state of execution of the task 105. As a result, the collaboration variable 106 is also changed and updated according to the change of the state and also change of requirement of active agents. For example, after a control step t, the robotic manipulator 700 may be unable to perform a sub-task of the task 105 without human intervention. Thus, the robotic manipulator 700 may submit an activation signal to a human seeking their assistance. This is explained previously in conjunction with FIG. 3D, FIG. 3E, and FIG. 3G.

FIG. 7B illustrates a schematic of an example task 705 that requires human robot collaboration, according to an embodiment of the present disclosure. The task 705 is for example an assembly task requiring assembly of a table 710, that involves placing and screwing 709 various components such as a wooden base 706, wooden set of support legs and legs 707, and screws 708. The task 705 may be performed collaboratively by a set of agents comprising the robotic manipulator 700 and a human 711 agent.

The task 705 can be completed in multiple valid orders. For instance, from the set of support legs and legs 707 the support legs may be positioned on the base and screwed in before positioning their corresponding legs and screwing the legs into their respective support legs. Alternatively, one may position a leg-support1, screw it into the base 706, place the leg1, screw it into the leg-support1, and analogously repeat the sequence for the other parts to complete the assembly of the table 710. Some embodiments are based on the realization that the simple positioning actions can be done independently by the robotic manipulator 700, while the screwing action requires the assistance of the human 711. While the speed of assembly could be increased by having the human 711 position parts in parallel from the beginning, the step-cost incurred due to the human's 711 presence would be quite high. To that end, the learned reward function of the controller 101 is configured to optimize both the reward obtained by completing the assembly sooner and the step-cost due to the human 711 being present.

For example, for the task 705, the optimal behavior must only call the human 711 into the task 705 when imperative. The team of the human 711 agent and the robotic manipulator 700 form the set of agents 102. Each agent has 8 discrete actions:
ChooseTask—This randomly assigns a valid next task to perform,
Pick—Agent picks up the current part,
Place—Agent places the current part at the goal location,
HoldInPlace—Agent holds the current part steadily at its current location,
ScrewIn—Agent screws the current part into place,
CallAgent—This calls the human into the task,
ResetTask—Agent places the current part back to its original location,
NoOp—No action.

The local state of each agent in the expert's oDec-MDP 120 consists of three discrete variables: TaskName-which takes a valid task name from eleven discrete values when a ChooseTask action is performed; TaskStatus—which describes the current status of the task through one of seven discrete values; Collab—which provides the current collaboration level between unavailable, partial and full collaboration. If the human 711 is called in for assistance with a screwing subtask, upon completion of that subtask, the human 711 may choose to stay idle by doing NoOp until the robotic manipulator 700 needs help again or may decide to participate by positioning other parts in parallel. The upside to the latter is that the task 705 is completed sooner and the team receives a better reward. In one embodiment, if the human 711 is engaged in a different task while the robotic manipulator 700 requires help, the human 711 must perform a ResetTask action to place the current part back before helping the robotic manipulator 700.

FIG. 7C illustrates an example flow diagram of a method 712 executed by the controller 101 for performing collaboratively, by the robotic manipulator 700 and the human 711, the task 705 of table assembly, according to an embodiment of the present disclosure. The robotic manipulator 700 and the human 711 form the set of agents 102. Any of these set of agents may be active or inactive during a control step, as per requirement of the discrete action at that control step. Method 712 begins with a choose task 712a action which is performed by the robotic manipulator 700 that chooses the next valid task to perform. In the example of FIG. 7C, the next task in method 712 is a pick 712b action, such as the robotic manipulator 700 picks a support leg for the table, and at next step a place 712c causes the support leg to be placed on the base for assembly. After the place 712c action, the robotic manipulator requests human assistance by a call agent 712d action. The call agent 712d action is equivalent to the call_agentID 310 action defined earlier in FIG. 3F. Through the call agent 712d action, the robotic manipulator 700 may send the activation signal 308 in the form of a pop-up notification for the ‘Call Agent’ action that is displayed on a graphical interface, such as a display screen, to garner the attention of the human 711 agent. For example, the human 711 agent's assistance is required in performing a screwing task.

FIG. 7D illustrates the method 712 steps that are executed when the human 711 is called for assistance for the assemble task 705. At 712e, a screw in action is performed by the human 711. After 712e, the robotic manipulator 700 and the human 711 work collaboratively to perform the task 705 and complete the rest of the assembly.

In an embodiment, the method 712 further comprises at 712f, performing a hold action where an agent holds the current part steadily at its current location.

To that end, the controller 101 enables efficient human robot collaboration in a manner that the human agent's intervention is minimized.

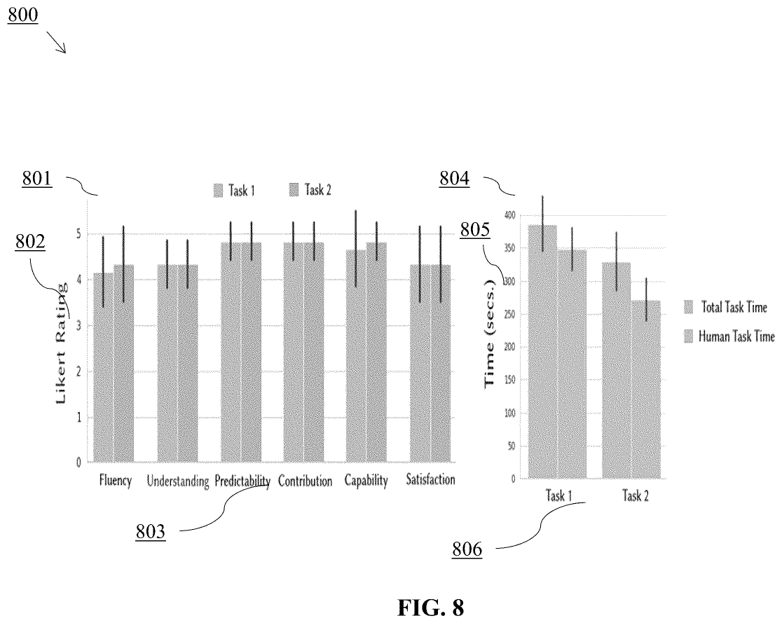

FIG. 8 illustrates graphical data 800 showing performance data of the controller 101 for executing the human robot collaborations tasks, according to an embodiment of the present dis closure. The graphical data 800 includes a graph 801 showing a 5-point Likert scale rating 802 on the y-axis for different parameters 803 of the task being provided on the x-axis for two tasks—task 1 and task 2. The parameters 803 include-fluency, understanding, predictability, contribution, capability, and satisfaction. Fewer or more parameters may be used for evaluating the performance of the two tasks. In the graph 801 the findings for subjective measures of task performance are rated on a 5-point scale.

Graph 804 depicts time 805 on the y-axis for performing task 1 and task 2. The time 805 includes average total duration of tasks and the average time allocated to human agents starting from the Call Agent action. For example, the graph 804 shows that task 1 takes an average of 386.76±41.19 secs for completion, while task 2 takes 348.42±32.28 secs. Through the ‘Call Agent’ action, on average, human agents only spend 329.49±43.98 secs on task 1 and 271.82±31.55 secs on task 2, demonstrating successful OHRC through an average time saving of approximately 18.39% for the human across both tasks.

In some embodiments, the performance of the controller 101 is evaluated using six statements for subjective evaluation and rate a level of agreement of various agents with these statements on a 5-point Likert scale.

According to the various embodiments, the time of execution of the task associated with the human agent is minimized for the task in the open human-robot collaboration environment in which the controller 101 operates.

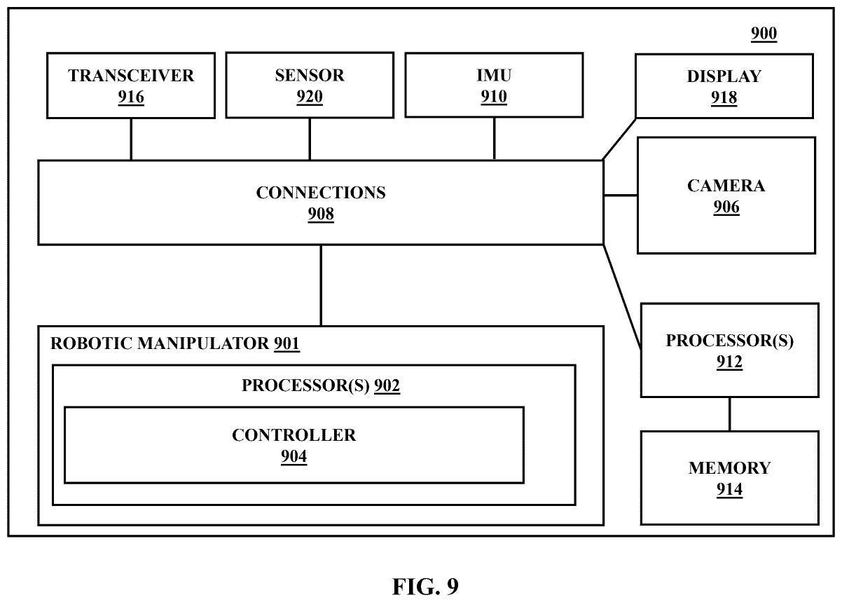

FIG. 9 illustrates some components of a control system 900 for controlling a robotic manipulator 901 according to a task, according to some embodiments. The control system 900 comprises communication interfaces such as a transceiver 916, sensors 920, input interface such as an inertial measurement unit (IMU) 910, output interfaces such as a display 918, one or more visual sensors such as a camera 906, computational circuitry realized through one or more processors 912 and memory 914. One or more connection buses 908 may couple the components of the control system 900 with each other. According to some embodiments, the control system 900 may also be coupled with the robotic manipulator 901. The robotic manipulator 901 comprises suitable processing circuitry realized through processors 902 and memory that stores a controller 904. The controller 904 is equivalent to the controller 101 described in conjunction with various embodiments disclosed above.

According to some embodiments, the modules described with reference to FIG. 1 to FIG. 8 may be executed by the processing/computation circuitry of the control system 900 to cause effective human robot collaboration in accordance with various embodiments described herein.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A controller for controlling a collaboration of a set of agents jointly performing a task, wherein the set of agents includes at least one robot, wherein for at least some of different control steps, the set of agents include different combinations of active agents and inactive agents defined by a collaboration variable, the controller includes circuitry configured to:
accept a feedback signal including observations of a state of execution of the task performed by the active agents from the set of agents specified by the collaboration variable;
process the observations with a neural network trained with machine learning to determine actions for the active agents specified by the collaboration variable, wherein the actions are selected from types of actions including activation actions calling for activating or deactivating a specific agent from the set of agents; and
update the collaboration variable; and output with the neural network at least one activation action from the activation actions to update a combination of active agents and inactive agents and cause the active agents to execute the determined actions, wherein the active agents and the inactive agents belong to the set of agents, and wherein the combination of active agents and inactive agents is one of the different combinations of active agents and inactive agents defined by the collaboration variable.

2. The controller of claim 1, wherein the neural network solves an open decentralized Markov decision process (oDec-MDP) model.

3. The controller of claim 2, wherein the neural network is trained with reinforcement learning based on the oDec-MDP model.

4. The controller of claim 2, wherein the neural network is trained with inverse reinforcement learning (IRL) based on the oDec-MDP model.

5. The controller of claim 2, wherein the oDec-MDP model is solved using open decentralized adversarial inverse reinforcement learning (o-Dec-AIRL), the o-Dec-AIRL comprising learning a common reward function for the task and a corresponding vector of learned policies based on one or more expert trajectories.

6. The controller of claim 5, wherein the common reward function is learned using inverse reinforcement learning contingent of the collaboration variable, a state space, and an action space.

7. The controller of claim 5, wherein the common reward function is used to learn the corresponding vector of learned policies, wherein the vector of learned policies includes one learned policy for each active agent involved in the task.

8. The controller of claim 1, wherein the circuitry is configured to generate an activation signal to cause a currently active agent to activate a currently inactive agent.

9. The controller of claim 8, wherein the currently active agent is a currently active robot, and the currently inactive agent is a currently inactive robot, and wherein the currently active robot submits the activation signal to the currently inactive robot.

10. The controller of claim 8, wherein the currently active agent is a currently active robot, and the currently inactive agent is a currently inactive human, and wherein the currently active robot submits the activation signal to the currently inactive human.

11. The controller of claim 8, wherein the activation signal is at least one of: a radio signal, an audio signal, and a video signal.

12. The controller of claim 1, wherein the collaboration variable is a binary vector of a size of the set of agents, wherein the state of execution of the task is formulated based on the binary vector before submission to the neural network.

13. The controller of claim 1, wherein the collaboration variable is a unique identifier natural number for each team of agents in the set of agents.

14. The controller of claim 1, wherein the set of agents comprises at least: a robot agent and a human agent such that either of the robot and the human is able to exit and enter the task during execution of the task in an open human-robot collaboration environment.

15. The controller of claim 14, wherein a time of execution of the task associated with the human agent is minimized for the task in the open human-robot collaboration environment.

16. The controller of claim 1, wherein the circuitry is configured to generate a control command that causes active agents to execute the determined actions.

17. A method for controlling a collaboration of a set of agents jointly performing a task, wherein the set of agents includes at least one robot, wherein for at least some of different control steps, the set of agents include different combinations of active agents and inactive agents defined by a collaboration variable, the method comprising:
accepting a feedback signal including observations of a state of execution of the task performed by active agents from the set of agents specified by the collaboration variable;
processing the observations with a neural network trained with machine learning to determine actions for the active agents specified by the collaboration variable, wherein the actions are selected from types of actions including activation actions calling for activating or deactivating a specific agent from the set of agents; and
updating the collaboration variable on the neural network outputting at least one activation action from the activation actions to update a combination of active agents and inactive agents and cause the active agents to execute the determined actions, wherein the active agents and the inactive agents belong to the set of agents, and wherein the combination of active agents and inactive agents is one of the different combinations of active agents and inactive agents defined by the collaboration variable.

18. The method of claim 17, wherein the neural network solves an open decentralized Markov decision process (oDec-MDP) model using policies trained with IRL.

19. The method of claim 17, wherein the collaboration variable is a unique identifier natural number for each team of agents in the set of agents.

20. A non-transitory computer readable medium having stored thereon instructions that when executed by a computer, cause the computer to perform a method for controlling a collaboration of a set of agents jointly performing a task, wherein the set of agents includes at least one robot, wherein for at least some of different control steps, the set of agents include different combinations of active agents and inactive agents defined by a collaboration variable, the method comprising:
accepting a feedback signal including observations of a state of execution of the task performed by active agents from the set of agents specified by the collaboration variable;
processing the observations with a neural network trained with machine learning to determine actions for the active agents specified by the collaboration variable, wherein the actions are selected from types of actions including activation actions calling for activating or deactivating a specific agent from the set of agents; and
updating the collaboration variable on the neural network outputting at least one activation action from the activation actions to update a combination of active agents and inactive agents and cause the active agents to execute the determined actions, wherein the active agents and the inactive agents belong to the set of agents, and wherein the combination of active agents and inactive agents is one of the different combinations of active agents and inactive agents defined by the collaboration variable.
